(19) United States
(12) Patent Application Publication
(10) Pub. No.: US 2021/0103295 A1
(43) Pub. Date: Apr. 8, 2021

(54) MACHINE LEARNING FOR MISSION SYSTEM

(71) Applicant: THALES, Courbevoie (FR)

(72) Inventors: Ludovic BILLAULT, MERIGNAC (FR); François COULMEAU, TOULOUSE (FR)

(21) Appl. No.: 17/039,055

(22) Filed: Sep. 30, 2020

(30) Foreign Application Priority Data
Oct. 3, 2019 (FR) 1910955

(51) Int. Cl. G05D 1/10; G06N 3/04; G06N 3/08; G08G 5/00

(52) U.S. Cl. CPC G05D 1/101; G06N 3/0436; G08G 5/0034; G06N 3/086; G06N 3/049

(57) ABSTRACT

A method and devices for machine learning applied to the mission trajectories of an aircraft are provided. Learning data comprise mission trajectories determined by an MMS mission computer and the corresponding avionic trajectories, such as those determined by certified avionic systems. Developments describe in particular steps of evaluation, e.g. use of cost function or mission score, optimization of the mission trajectories by means of evolutionary, in particular genetic, methods, the use of fuzzy logic, the display of intermediate results or other things for explanatory purposes. Software and hardware aspects (e.g. neural networks) are described.

### CROSS-REFERENCE TO RELATED APPLICATIONS

This application claims priority to foreign French patent application No. FR 1910955, filed on Oct. 3, 2019, the disclosure of which is incorporated by reference in its entirety.

### FIELD OF THE INVENTION

The document relates to mission management methods and systems (MMS for “mission management system”) for aircraft or drones, and pertains more particularly to interfaces with autopilot (AP for “automatic pilot”) and flight management (FMS for “flight management system”) systems.

### BACKGROUND

A drone or an aircraft is able to carry out a wide range of missions (e.g. objectives, instrumentation, etc.). A mission implements various sensors (radar, FLIR, etc.) and/or actuators (load, etc.).

In order to carry out a specific mission, it may for example be required to finely control the trajectory and/or the altitude of the aircraft. The trajectory and the altitude of an aircraft are controlled by elements of the avionics, in particular the FMS flight management system and/or the AP (autopilot). On the basis of the mission data, the FMS/AP duo will calculate and fly a trajectory that observes the A424/A702 standard constraints and will ensure the flyability of the trajectory according to the aerodynamics of the vehicle.

Currently, the exchanges between management system and FMS/AP systems take place in a single direction: the mission computer determines a 2D/3D trajectory for carrying out its mission, then transmits it to the FMS and/or to the autopilot system. These latter two systems are run while observing the mission trajectory instruction as best they can. Deviations then occur systematically between the trajectory instruction and what is actually flown by the aircraft.

Among the many technical problems which arise with automatic piloting, a first technical problem lies in the fact that the mission computer is not aware of the performance of the aircraft (e.g. flight envelope, capability in terms of speed, roll, etc.).

For example, to carry out a search-and-rescue mission, it is first necessary to determine the trajectory of the aircraft in order to be able carry out the search in a suitable manner (“search pattern”) and then to ensure that the sensors are correctly configured despite the manoeuvres of the aircraft (i.e. roll, pitch). If the mission consists in surveying a geographical region, the aircraft should be positioned at a precise attitude (for example in order to produce a radar SAR image). If the mission consists in carrying out a reconnaissance mission, it may be necessary to define one or more regions to be avoided.

The technical problem common to all of these situations is that the mission computer might not be (sufficiently) aware of the performance of the aircraft (i.e. flight envelope, capability in terms of speed, roll, etc.), which are equally constraints to be observed. It is therefore important to be able to finely control the orders to the FMS in order for it to generate a trajectory that observes these constraints. Additionally, it is important, if possible, not to overload a certified avionic core, which constitutes a “precious” resource since it delivers an “avionic” trajectory whose characteristics are special in the sense that they come from a certified system. Lastly, it is also recommended not to misuse avionic systems because FMS calculations may be slow (although they can be simulated in certain cases). There are therefore substantial advantages to being frugal regarding the mission trajectories that are entered into avionic systems; in other words, avionic core systems should be used wisely.

Some approaches for solving these problems are known. In a first approach, the trajectory is directly managed by the pilot (giving or not giving orders to autopilot system) as instructed by the TACO (“tactical operator”). This approach results in a substantial workload, both for the TACO and for the pilot, in order to coordinate themselves and generate the orders for the AP or pilot directly. In another approach, certain FMS flight management systems propose generating a trajectory on the basis of standard patterns (search-and-rescue mission in a ladder, spiral, etc. pattern). Unfortunately, these patterns do not cover all of the needs and/or constraints that are cited above (in particular the management of exclusion zones, aircraft altitude, etc.).

The patent literature does not describe any satisfactory solutions. Patent document FR1302628 describes the integration of mission constraints into an FMS flight management system. Trajectories from various computers are chained together into a single resulting trajectory, flown according to the FMS/AP. This approach has limitations. Patent document FR1402042 compares a trajectory from a mission computer with a trajectory ultimately flown by an FMS. The document proposes using rules to transform the trajectory from the mission computer into a trajectory in FMS format. This approach also has limitations.

### SUMMARY OF THE INVENTION

The document relates to methods and devices for machine learning applied to the mission trajectories of an aircraft. Learning data comprise mission trajectories determined by an MMS mission computer and the corresponding avionic trajectories, such as those determined by certified FMS/AP avionic systems. Developments describe in particular steps of evaluation, e.g. use of cost function or mission score, optimization of the mission trajectories by means of evolutionary, in particular genetic, methods, the use of fuzzy logic, the display of intermediate results or other things for explanatory purposes. Software and hardware aspects (e.g. neural networks) are described.

Advantageously, the embodiments of the invention allow a coupling between the mission system and the portion managing the trajectory of the aircraft.

Advantageously, in contrast to the existing solutions, the embodiments of the invention propose a bilateral exchange of data between a mission system on the one hand and an FMS/AP-type system.

Advantageously, the method according to the invention makes it possible to observe in fine the constraints from the mission computer, by virtue of the addition of a feedback loop. In contrast, the known approaches have to make do with observing the difference between what has been proposed and what will ultimately be flown (or not).

Advantageously, in contrast with known solutions, the method according to the invention makes it possible to ensure that the resulting trajectory will observe the constraints from the FMS and/or from the PA.

Advantageously, according to the invention, the mission computer does not need to include the aerodynamic equations from the FMS/AP. “Offline” relearning, for example on the same simulations, with various {mission computer/FMS/AP} pairs, allows each portion of the pair to be easily adjusted.

In one embodiment, the method according to the invention comprises a step consisting in learning the capabilities of the aircraft or more precisely in learning which mission trajectory instructions are the most likely to be carried out exactly by the aircraft, by using in particular machine learning techniques.

In one embodiment, the method according to the invention comprises a step consisting in using one or more evolutionary techniques (e.g. genetic algorithms, “GFT” genetic fuzzy-logic decision trees) in order to model the non-linearities of the problem as well as possible.

Advantageously, the mission computer does not need to include the aerodynamic equations from the FMS/AP. “Offline” relearning on the same simulations with various types of coupling between them, the mission computer on the one hand and the FMS/AP on the other hand, may allow various types of coupling. It is therefore possible to interchange the units. This combinatorial flexibility improves the speed of learning, in particular its need to know the properties of one of the two portions of the pair.

### BRIEF DESCRIPTION OF THE DRAWINGS

Other features and advantages of the invention will become apparent with the aid of the following description and the figures of the appended drawings, in which:

FIG. 1 illustrates examples of steps of one embodiment of the invention;

FIG. 2 illustrates the variety of machine learning methods that can be employed in the method according to the invention;

FIG. 3 illustrates one embodiment in which the machine learning uses a genetic algorithm;

FIG. 4 illustrates, in three dimensions, an exemplary SAR mission 410;

FIG. 5 illustrates the steps of calculating a trajectory for the exemplary SAR mission 410;

FIG. 6 illustrates the image coverage by the sensor according to the trajectory 410;

FIG. 7 illustrates the actual trajectory 710 of the aircraft;

FIG. 8 illustrates the actual coverage 810 of the sensor.

### DETAILED DESCRIPTION

According to the embodiments of the invention, an “aircraft” may be a drone, a commercial aeroplane, a cargo plane, or even a helicopter, which might or might not have passengers on board. More generally, the term “aircraft” in the description below may be replaced with the terms vehicle, car, lorry, bus, train, motorbike, boat, robot, submarine, toy, etc. or any element that may be remotely piloted (by radio, satellite, or other link), at least partially (intermittently, or periodically, or even opportunistically over time).

Various types of machine learning are possible. Machine learning is a field in computer science that uses statistical techniques to endow computer systems with the ability to “learn” using data (for example to gradually improve performance for a specific task) without being explicitly programmed for this purpose.

Machine learning is useful for detecting and recognizing trends, patterns or relationships. It is generally easier to gather data (for example data on a video or board game) than to explicitly write the program governing the game in question. Moreover, neural networks (hardware embodiment of machine learning, or software emulation) may be repurposed to process new data. Machine learning may be performed on particularly large amounts of data, i.e. by using as much data as possible (e.g. stability, convergence, weak signals, etc.) New data may be added continuously and the learning may be refined.

Various learning algorithms may be used, in combination with the features according to the invention. The method may comprise one or more algorithms from the algorithms comprising: support-vector machines (SVMs); “boosting” (classifiers); neural networks (in unsupervised learning); decision trees (“random forest”); statistical methods such as Gaussian mixture modelling, logistic regression, linear discriminant analysis and genetic algorithms.

Machine learning tasks are generally classified according to two large categories, depending on whether there is a “signal”, or learning inputs, or “information feedback”, or available outputs.

The expression “supervised learning” refers to a situation in which the computer is presented with exemplary inputs and exemplary outputs (whether real or desired). The learning then consists in identifying linking rules that match the inputs to the outputs (these rules may or may not be possible for a human to understand).

The expression “semi-supervised learning” refers to a situation in which the computer receives only an incomplete set of data: for example some output data are missing. It is therefore possible to add missing data to switch to an unsupervised mode. Another means consists in using external filters (corresponding for example to known scenarios), in order to filter the output data and confirm/disconfirm the anomalies detected by unsupervised learning. Lastly, it is possible to adjust the weighting between the various algorithms implemented for the detection of anomalies and/or to set one or more parameters thereof. The expression “semi-supervised” therefore does not mean that human input is required (at least directly).

The expression “reinforcement learning” consists in learning the actions to take, on the basis of experimentation, so as to optimize a quantitative reward over time. Through iterative experimentation, a decision-making behaviour (referred to as strategy or policy, which is a function associating the action to be carried out with the current state) is determined as being optimal if it maximizes the sum of rewards over time.

The expression “unsupervised learning” (also referred to as “deep learning”) refers to a situation in which there is no (or very little) labelling (e.g. no explanation, description, etc.), leaving it to the learning algorithm alone to find one or more structures between inputs and outputs. Unsupervised learning may be an objective in itself (uncovering hidden structures in data) or a means for reaching an objective (learning by functionality).

Depending on the embodiment, the human contribution in the machine-learning steps may vary. In some embodiments, machine learning is applied to the machine learning itself (reflexive). The entire learning process may in fact be automated, in particular by using a number of models and comparing the results produced by these models. In the majority of cases, humans participate in the machine learning (“human in the loop”). Developers or curators are responsible for maintaining data collections: data inmanagement, data cleaning, model discovery, etc. in some cases, no human intervention is needed, and the learning is fully automated once the data have been made available.

In computer science, an “online algorithm” is an algorithm that, rather than receiving its input in one go, receives it as a data stream and must make decisions on the fly. In the context of machine learning, the term “incremental learning algorithm” may be used.

Since it does not have access to all of the data, an incremental learning algorithm must make choices that may turn out to be non-optimal a posteriori. It is possible to perform competitive analyses by comparing the performance, on the same data, of the incremental learning algorithm and of the equivalent having all of the data available to it. Online algorithms comprise in particular algorithms such as the k-server, BALANCE2, balanced-slack, double-coverage, equipoise, handicap, harmonic, random-slack, tight-span, tree and work-function algorithms. Online algorithms are related to probabilistic and approximation algorithms.

In one embodiment, the machine learning is performed online. In one embodiment, the machine learning may be performed incrementally or online. From a known average generic model (aircraft type or series), a particular aircraft may be characterized, and this gradually refined, as it makes its own flights (by serial or tail number). When the model is known, it is possible to continue learning by data stream (to improve the existing model without starting from scratch). Offline machine learning learns on the basis of a complete dataset while online learning may continue to learn (transfer learning), on board, without having to re-ingest the starting data.

In one embodiment, the machine learning is performed offline. The recordings may be recordings of past flights (data-mining approaches). This embodiment is advantageous in that it allows existing data (of which there are a lot and these data are currently underused) to be reused.

It should be noted that the machine learning implemented in the method according to the invention may comprise both types of learning: offline learning allows for example the generic aircraft model to be parametrized and online learning then allows the model that is unique to each particular aircraft to be parametrized. (However, offline learning may also be used to specify a particular aircraft.) It is also possible to use only one type of learning (one airline may be interested only in the aircraft class while another airline will want to know the specific characteristics of a given aircraft, for example for fine optimization of fuel consumption).

In one embodiment, the system further comprises one or more neural networks chosen from the neural networks comprising: an artificial neural network; an acyclic artificial neural network; a recurrent neural network; a feedforward neural network; a convolutional neural network; and/or a generative adversarial neural network.

What is described is machine learning method implemented by computer for assisting in the management of the mission trajectory of an aircraft, comprising the steps of: receiving learning data, comprising mission trajectories, determined by an MMS mission computer, a mission trajectory (110) being associated with mission constraints, and actual trajectories, referred to as avionic trajectories (130), determined by an FMS FMS flight management system and/or an AP autopilot system, referred to as FMS/AP avionic systems; executing a machine learning algorithm on the learning data, said machine learning algorithm using a cost function, in particular a mission score associated with each avionic trajectory, according to predefined criteria; generating a trained model for assisting in the management of the mission trajectory of an aircraft.

What is described is method implemented by computer for assisting in the management of the mission trajectory of an aircraft, comprising the steps of: receiving a mission trajectory from an MMS mission computer, said mission trajectory being associated with mission constraints; on the basis of the mission trajectory, determining one or more actual trajectories, referred to as avionic trajectories, by means of an FMS flight management system and/or an AP autopilot system, referred to as FMS/AP avionic systems; evaluating said one or more actual trajectories, referred to as avionic trajectories, in particular by determining a mission score associated with each avionic trajectory, according to predefined criteria; carrying out or performing machine learning between the mission trajectories communicated by the MMS mission computer on the one hand and said mission scores associated with the avionic trajectories determined by the FMS/AP avionic systems on the other hand.

In one development, the machine learning (121) comprises reinforcement supervised learning (2212).

In one development, the machine learning (121) comprises a GFT genetic fuzzy-logic decision tree (2213).

In one development, the machine learning (121) comprises the implementation of a genetic algorithm (2211), which generates mission trajectories and then selects one or more trajectories generated, the generation consisting in breaking a mission trajectory down into a plurality of genes, comprising elementary geometric units associated with attributes, then in randomly mixing one or more broken-down trajectories and/or randomly replacing one or more genes with others.

In one development, the implementation of a genetic algorithm comprises the steps of: breaking one mission trajectory from among X down into a succession of N unitary geometric elements, each elementary unit being associated with P attributes, the various combinations N×P being called genes, and one attribute being chosen from among the speed, altitude, direction of the aircraft comprising in particular the roll axis, the pitch axis, and the yaw axis; performing one or more crosses and/or one or more mutations of genes, in order to generate mission trajectories; a cross being performed by randomly intermixing one or more trajectories, and a mutation being able to be made by selecting a gene at random and replacing the selected gene with another gene; determining the mission score for each mission trajectory generated; selecting one or more mission trajectories according to the mission scores; said selection being performed by thresholding and/or by means of threshold ranges and/or by filtering by analytic function and/or by algorithm-computable filtering.

In one development, the method further comprises the step of implementing a fuzzy-logic algorithm configured to generate the trajectories, the genetic algorithm allowing the fuzzy-logic control parameters to be selected from among all of the trajectories generated.

In one development, the machine learning (121) comprises deep learning.

In one development, a mission constraint comprising one or more of the parameters comprising a mission type, a geographical region, a point of entry into and/or of exit from said geographical region, time management, fuel management and/or a quality of service as a target regarding one or more sensors on board the aircraft.

In one development, a mission score is a ratio of a target or expected quality of service associated with the mission trajectory to a resulting quality of service associated with the avionic trajectory corresponding to the mission trajectory, a quality of service being associated with at least one or more onboard sensors.

In one development, the trained model determines an optimized mission trajectory, which satisfies the mission constraints received and compliant for the avionic systems. In one development, the model modifies a received mission trajectory into a modified mission trajectory which will correspond to an avionic trajectory associated with a modified mission score higher than that which would have been obtained with the received mission trajectory. In one development, the trained model modifies one or more mission constraints (same types of results or objectives). In one development, the trained model modifies and/or filters and/or optimizes and/or selects and/or weights the mission constraints and/or the mission trajectories.

In one development, one or more of the intermediate results of calculations of the method, information relating to the root causes and/or the computing context of one or more of the steps of the method is the subject of display in a human-machine interface.

For example, the method may comprise the step of delivering at least one trajectory from among said mission trajectories generated and then selected to the pilot and/or to the FMS/AP avionic systems.

The human-machine interaction is discussed below. A method according to the invention may comprise one or more feedback loops (e.g. downstream retroacting on the upstream, feedforward, etc.). A feedback loop may be “closed” i.e. inaccessible to human control (it is run by the machine). It may be “open” (e.g. step of displaying in a human-machine interface, validation or any other system of human confirmation). Various embodiments may result in different implementations by closing or opening one or more open or closed loops, respectively. For example, the method according to the invention may involve only open feedback loops (i.e. the pilot intervenes at every stage), or only closed feedback loops (e.g. complete automation), or else a combination of the two (the human contribution being variable or configurable). As such, the method (which may be an “artificial intelligence” method) may be interpreted as being “transparent”, in that it is controllable. The display may regard intermediate results of calculations, information relating to the root causes and/or to the computing context. As such, the method may be considered to be “explainable”.

What is described is a computer program product comprising instructions for implementing one or more steps of the method.

What is described is a (machine learning) system for assisting in the management of the mission trajectory of an aircraft, comprising: an MMS mission computer, configured to determine mission trajectories on the basis of mission constraints; an FMS flight management system and/or an AP autopilot system, referred to as FMS/AP avionic systems; one or more processors configured to determine an evaluation, in particular a mission score associated with each avionic trajectory, according to predefined criteria; a neural network configured to perform machine learning (121) between the mission trajectories communicated by the MMS mission computer on the one hand and said mission scores.

In one development, one or more processors are configured to implement a genetic algorithm and/or a fuzzy-logic algorithm.

In one development, a neural network is chosen from among the neural networks comprising: an artificial neural network; an acyclic artificial neural network; a recurrent neural network; a feedforward neural network; a convolutional neural network; and/or a generative adversarial neural network.

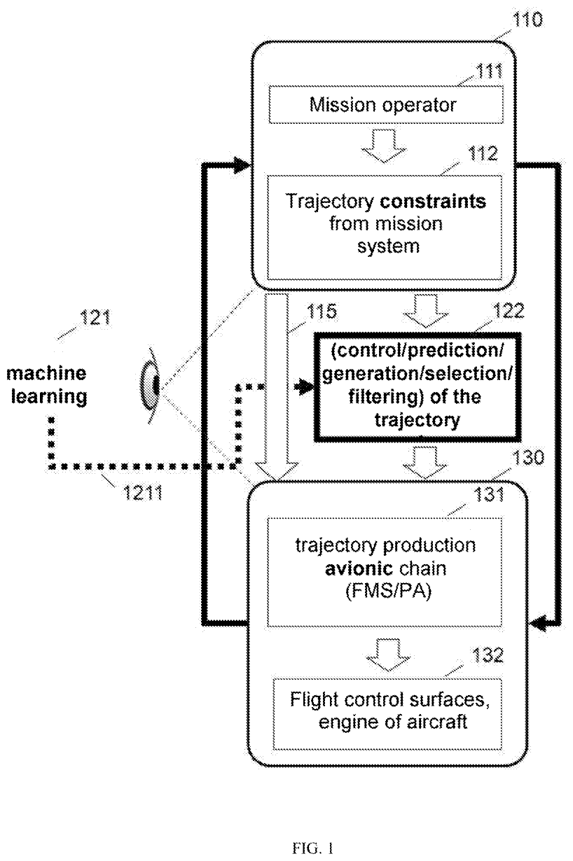

FIG. 1 shows how machine learning which “observes” or “learns” (then “optimizes”, “predicts”, “selects”, “configures”, etc.) the coupling between mission trajectories 110 and “avionic” trajectories 130 (i.e. trajectories calculated by the certified avionics).

Using a mission operator 111, one or more trajectory constraints are determined by the mission system 112. These constraints are transmitted 115 to the avionics 130. The avionics comprise a chain for producing a trajectory 131 (e.g. the FMS/AP flight management system). The avionics 130 optionally comprise the hardware systems for flight control surfaces and engines of the aircraft 132 (i.e. the effectors which perform the determined flight).

This data stream is observed, and is the subject of machine learning 121 (according to various techniques which will be provided below).

In one embodiment, an intermediate “control module” 122 is inserted, which may manipulate the output from 110 and/or the input to 130. What is meant by “manipulate”, according to the embodiments, is “control”, “predict”, generate” (e.g. mutate/cross) or “select” the mission trajectory and its constraints and/or the input submitted to the avionic chain.

In one embodiment, the method according to the invention comprises an intermediate control step 122 between the mission system 110 (which produces the constraints on the trajectory) and the chain for producing the trajectory 130 (FMS/AP). In one embodiment, this control module or step comprises the trained model. In one embodiment, the trained model comprises this module or this control step.

In one embodiment, this control step or module 122 is coupled with the avionic systems 131 that determine the trajectory in an aircraft.

Advantageously, the existence of this control module 122 makes it possible to lessen the load on the pilot and on the TACO (since the pilot now only has to approve the trajectory order proposals). In one embodiment, this control module allows the pilot and/or the TACO to choose to modify—or not to modify—the trajectory order proposals. Specifically, these FMS orders are standardized and known to the pilot and/or TACO, who may act (without cognitive overload, or additional formation) on these orders (in one embodiment, the system indicates the effects of the modifications on the trajectory).

The control step or module 122 makes it possible in particular to produce the orders for the flight management system FMS 131 in order to observe the constraints 112 associated with the trajectory, while observing the standardization of these orders. It determines the orders for the FMS 131 according to the expected results on the trajectory. It acts in a certain respect as an f-1 function (“pre-function”) of the chain for producing the trajectory to result in observing the constraints desired for the one or more missions in question.

The intermediate character of the control module 122 lastly makes it possible not to modify the chain for producing the trajectory 130. Specifically, this production chain is subject to strict development standards (e.g. DO178). It is therefore advantageous for an aircraft manufacturer and/or operator to be able to retain the benefits of certification of this chain (e.g. aircraft retrofit market, etc.)

### Learning (121)

In one embodiment, the intermediate control module 122 uses one or more machine learning steps 121.

This machine learning 121 may pertain to the differences between what the mission system proposes 110 and what the certified chain of the aircraft 130 calculates. Following this learning 121, the mission computer may be be capable of finding its own settings (learnt), so that the FMS is able to observe its mission constraints.

In one embodiment, the machine learning 121 may consist in using what is referred to as a “fitness” function for the output of the production chain 130, by giving a “grade” (or a score or any other quantification) to this output 1211 regarding the trajectory constraints from the mission system 110.

One or more machine learning mechanisms may then be used to adjust or optimize the module of controlling 122 the trajectory.

According to the embodiments, the machine learning steps 121 may be performed through simulation means.

The mission system may for example produce a simulated mission trajectory, corresponding to the mission constraints. The FMS flight management system 131 then produces a trajectory based on said mission trajectory according to the actual capabilities of the aircraft (e.g. aerodynamics, flight envelope, engine performance, etc.). The trajectory calculated by the FMS is then evaluated: for example, the level to which said trajectory satisfies the constraints from the mission system is determined.

According to the availability of hardware and/or software (e.g. loads, ongoing demands, etc.), it may be more advantageous to use the flight management system producing an FMS trajectory (and potentially the AP) directly.

In one embodiment, the method according to the invention comprises a step of modelling or characterizing a mission operator as a plurality of parameters, referred to below as hyper-parameters or attributes.

Specifically, a mission is defined by parameters (some of which are optional): the mission type, the geographical region, a point of entry into and/or of exit from said geographical region, mission time management, a quality of service and fuel management.

The mission may for example be a SAR (search-and-rescue) mission, an LLF (low-level flight) mission, a drop, a rendez-vous, a resupply mission, etc. The geographical region may be a 2D or 3D region (freeform, polygon, polyhedron, etc.); it is the region in which the mobile unit will carry out the mission. A point of entry and/or of exit may be determined in the geographical region. These points may be predefined, configured or configurable etc. an entry region may for example be determined in two or three dimensions. An entry/exit angle may also be associated therewith. In terms of managing the mission time, the mission duration may be expressed in absolute terms (e.g. mission start time, finish time) or relative terms (e.g. mission duration, min and/or max time in the region). The time parameters may sometimes be implicit (e.g. providing a minimum or maximum mission speed). The concept of quality of service may be complex. For a mission involving the use of sensors, particular indicators may be determined and tracked. For example, for a SAR mission, EO/IR (electro-optical/infrared), radar or other sensors may be used to search for an object in the geographical region. The minimum resolution of the image and the coverage of the region may be required quality of service parameters. For a drop mission, the status of the aeroplane at the drop point (position, altitude, orientation (pitch/roll/yaw), angle of attack, speed) may constitute one of the required quality of service parameters.

Score (220)

In one embodiment, a feedback loop is made from the downstream to the upstream, in this instance by the avionic trajectory chain 130 to the mission management 110. As such, the mission computer 110 may “integrate” or “internalize” the “limitations” of the actual trajectory in order to determine a mission trajectory which meets the mission requirements, once actually carried out.

In one embodiment, the mission requirements will be concretized in the form of a mission “score” 220 (for example the level of image coverage of the mission geographical region for a SAR-type mission using EO/IR sensors).

In one embodiment, a control module employs machine learning steps. This means learning, in the sense of supervised learning: samples comprising starting mission trajectories mission and resulting trajectories are supplied to the learning algorithm; the grading is based on the score which measures the difference between the required quality of service and the resulting quality of service. The algorithm thus “learns” the correlations between the mission trajectories and the score. In this sense, the resulting trajectory is only an intermediate calculation allowing the mission score to be calculated.

The learning samples therefore consist of attributes (“features”) from the second step; they therefore depend on the characteristics of the mission trajectory.

The mission trajectory is modelled in the form of a succession of mission patterns, which integrates the constraints from the first step.

In one embodiment, a mission trajectory may be modelled by a succession of elementary trajectory elements, expressed in 2D and/or 3D and/or 4D (by integrating the speed). In one embodiment, an elementary trajectory element is a portion of a straight and/or a curve. In one embodiment, a curve may be a circular arc. In one embodiment, a curve is a portion of an ellipse. In one optional embodiment, a speed is associated with each trajectory element. In one embodiment, a ground gradient (or air gradient, vertical speed, or climb/descent curve) is associated with each trajectory element in order to model its vertical change.

In one embodiment, a pattern corresponds to a single unitary element.

In one variant embodiment, a pattern comprises a succession of N (N>1) unitary elements: the advantage of this implementation is that it allows transitions to be modelled, i.e. changes of heading, of speed, of element type, of rate of turn, etc.

In one embodiment, the resulting trajectory (that which is actually flown by the aircraft; calculated by the FMS/AP) is also supplied as input to the learning algorithm. In one embodiment, the resulting trajectory consists of unitary trajectory elements of the same type as the mission trajectory elements (succession of “straights” and of “curves” for example). In one alternative, the resulting trajectory consists of more complex elements (curves in the form of polynomials, etc.)

In one embodiment of the invention, the mission success score is determined. This score indicates the ratio of the “resulting” (actual, flown) quality of service to the required (requested, desired) quality of service. In one implementation, this ratio is predefined (it is supplied by or received from a third party). In one alternative, the two types of quality of service are predefined (QoS indicator supplied, received). The required quality of service indicates for example to the sensor coverage of the mission trajectory. The resulting quality of service indicates for example the sensor coverage of the resulting trajectory.

The set of samples (of data) delivered as input to the learning algorithm comprises simulated samples and/or actual samples.

A simulated sample comprises data from one or more simulations. In the example illustrated, SAR-type mission trajectories may be simulated, for example by acting on the type of pattern, the width and length of the unitary trajectory elements, the speed, etc. These simulated trajectories are communicated to the FMS/AP which deduces the resulting trajectories therefrom. Lastly, the quality of service (for example of coverage) is determined or simulated, so as to determine a mission success score (or to deduce raw characteristics therefrom, for example the resulting coverage of the sensor in relation to the required coverage).

An actual sample comprises data from one or more trajectories actually flown by the aircraft during missions or training exercises.

These attributes (simulated vs. actual) may also be communicated as input to the learning algorithm.

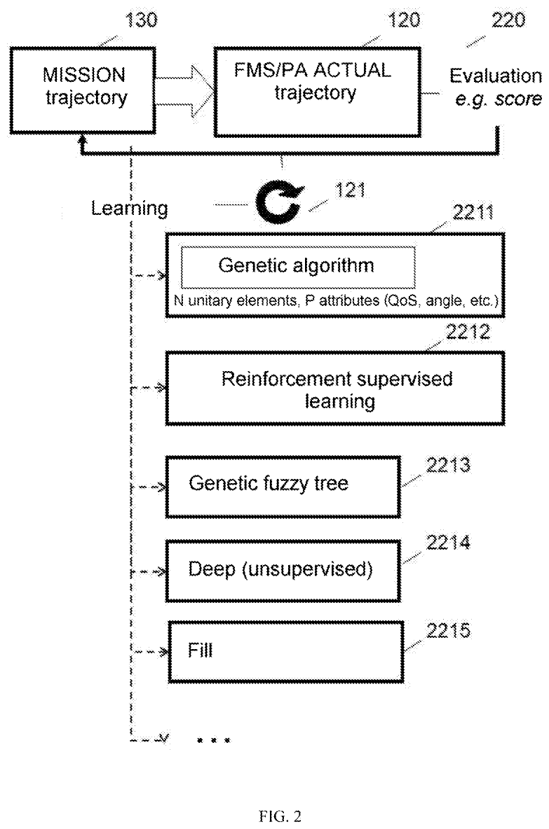

FIG. 2 illustrates the variety of machine learning methods that can be employed in the method according to the invention.

In one embodiment, the machine learning 121 comprises one or more machine learning steps using a genetic algorithm 2211. This embodiment is particularly advantageous for selecting the best mission settings, which will satisfy in fine the mission constraints and whose calculations will be performed quickly.

In one embodiment, the machine learning comprises one or more learning steps using reinforcement supervised learning.

In one embodiment, the machine learning comprises one or more learning steps using a GFT for “genetic fuzzy tree” (2213). The principle of GFT learning is to combine fuzzy-logic control techniques with learning on the control parameters from these logics via genetic mechanisms.

Fuzzy logic therefore makes it possible to produce control orders on the basis of inputs. These orders are produced using “linear” laws (a minima), dependent on “control parameters”. The step of determining orders for the FMS/AP may be guided, governed or supervised by a fuzzy-logic control set.

In one embodiment, the machine learning may make it possible to best adjust (or optimize) the fuzzy-logic control parameters, such that the mission success score is as high as possible (calculated by the fitness function).

The fuzzy logic intervenes in certain aspects as a pilot who knows their aircraft would: the pilot eventually knows which orders to produce in order to have an optimal mission outcome.

In the same way as for the genetic algorithm, the orders to produce for the FMS/AP and/or the one or more sensors are the patterns described above.

Each unitary parameter may correspond to a fuzzy-logic control.

For example, control number 1 may correspond to the orientation order of the 1st unitary element, control number 2 will correspond to the speed order of the 1st unitary element, etc., control number n will correspond to the orientation order of the 1st unitary element, and so on until all of the parameters of each unitary element have been covered.

A fuzzy-logic tree set may therefore be used to produce all of the parameters associated with the unitary elements.

The use of genetic mechanisms makes it possible to vary the internal control parameters of the various fuzzy logics and to result in an optimized assembly for all of the missions in question.

In one embodiment, it will be possible to use a set of different internal control parameters for each mission parameter type (i.e. types of missions). The fuzzy-logic algorithms could therefore be optimized according to the types of missions.

In one embodiment of the invention, the control algorithm may be based on a neural network. If applicable, the learning occurs by backpropagation, so as to optimize the weightings of the various neurons involved. In one embodiment, in this instance, the output of each neuron in the last layer may correspond, respectively, to the orientation and speed orders of each unitary element (like what is proposed for the GFT-type algorithm).

In one embodiment, the optimization may be carried out so as to maximize the mission success score (in other words to minimize the difference between the resulting quality of service and that required each type of mission).

In one embodiment, the method comprises a step of determining the trajectory of the aircraft according to the FMS/AP avionic systems. After receiving a new mission, and its mission constraints or parameters, one step of the method may consist in calculating the mission trajectory according to a trained genetic algorithm. The FMS/PA avionic systems then determine the resulting trajectory.

In one embodiment, the method comprises a step consisting in executing the flight of the resulting trajectory. Flight commands (e.g. flight control surfaces, engines, propellers) are communicated to the flight systems in order to effectively fly the resulting trajectory.

In one embodiment, the orders are sent to the sensors in order to track the sensor quality of service parameters along the trajectory flown.

In one embodiment, the learning is deep learning 2114, unsupervised learning, see above.

In one embodiment, the learning takes place via fill algorithm (2215). (For example, by using a Peano curve-type fill function or a Hilbert curve-type function). These curves have the property of filling the space while ensuring continuity (the function is continuous over time or curvilinear distance for example). It is therefore a journey over the entire surface, which covers every pixel. The order of the algorithm, i.e. the depth of recursiveness, makes it possible to cross more or fewer points of the space to be covered. In the context of the invention, for a SAR manoeuvre for example, the depth may be calculated such that the sensor has visibility over the entire space to be covered. This calculation may be based on the track on the ground covered at any given time by the sensor.

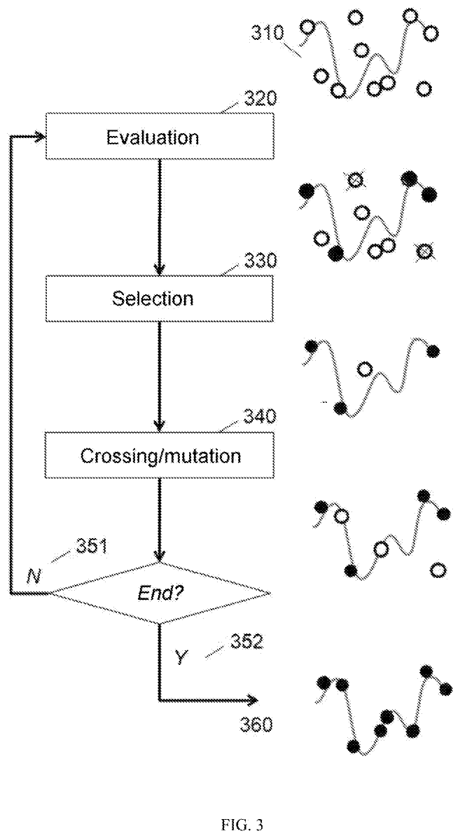

FIG. 3 illustrates one embodiment in which the machine learning uses a genetic algorithm.

The starting or base population 310 consists of X samples.

The implementation of the genetic algorithm may comprise the steps of:
a step of receiving or determining a succession of N unitary elements (called “genes” hereinafter) forming the mission trajectory (if necessary, the samples having fewer than N unitary elements are standardized, i.e. modified so as to obtain the same number of unitary elements)
the number N corresponds here to an interval of integration; it will give a unitary element of a known and constant length. The greater N, the more discretized the trajectory, and the more the combinatorics increase. This number N may be predefined or else received from/determined by a third party
the unitary elements comprise at least one orientation element; this may be the orientation with respect to north (between 0 and 359° for example, in intervals of) 1°; 360 possible “genes” are then obtained;
a step of decreasing the number of genes for the type of mission. Thus, in the SAR example illustrated in the preceding figures, there are four different genes (upwards, to the right, to the left, downwards). In one alternative, the outward and return trips may be limited.

Optionally, a speed (or a change of speed: constant, acceleration, deceleration) is associated with each unitary element. The speed may be any speed between a min speed and a max speed, in intervals of X m/s in order to limit the number of possible “genes”. For example, for a rotor drone, a speed between 0 and 30 m/s in intervals of 1 m/s results in 31 possible genes.

Optionally, an altitude (or a change of altitude: constant, climb, descent) is associated with each unitary element. The altitude may be any altitude between a min altitude and a max altitude, in intervals of X metres in order to limit the number of possible “genes”. For example, for a rotor drone, an altitude between 10 and 1000 m in intervals of 20 m results in 50 possible genes.

Optionally, a quality of service is associated with each unitary element (aperture and/or resolution of the sensor in the case of the SAR example). An EO/IR sensor may have a non-constant aperture, in steps between a min aperture of 10° and a max aperture of 60° for example, in increments of 1°, which results in 50 genes.

In the base population 310, comprising X samples, each sample is formed of N genes, said N genes being characterized by an n-tuple between the optional types associated with the unitary elements). For example, by considering 4 unitary elements (N=4), 10 speed possibilities, 3 altitude possibilities and a constant sensor aperture, this results in 120 possible genes for each sample.

One step of the method consists in evaluating 320. The mission trajectory—associated with each sample—is injected into an FMS/AP-type system which calculates the resulting trajectory. This calculation will make it possible to take into account the actual aerodynamics of the aircraft, flight envelope limitations (e.g. constraints on the status), limitations due to regulations or design (max rate of turn, max acceleration, etc.), maintenance constraints or passenger comfort (limitation on the number of changes in speed, altitude, etc.). On the basis of the resulting trajectory, the mission score is calculated.

One step of the method consists in selecting 330 one or more from among the X samples of the population 310, according to their score. Various embodiments are conceivable (e.g. thresholding, ranges of thresholds, analytical functions, etc.). In one embodiment, the k samples having the best score (k<X) are selected, k being received or calculated. In one embodiment, k is predefined. For example, k=X/2. In one embodiment, only those samples having a score higher than a predefined threshold are retained (for example the k samples having a score higher than 70%, if the score is between 0 and 100%). In one embodiment, one or more of the thresholds used are dependent on the iteration of the algorithm (increasing selectivity). In one embodiment, the selection is made using a “biased wheel” method: the samples are selected in proportion to their score (more samples with a high score are selected than with a low score). In one embodiment, the B best scores are compulsorily retained. All of these embodiments may be combined with one another (parametric selection, selection by analytical functions in an algorithmic manner).

One step of the method 340 consists in crossing and/or muting the k samples retained. Here again, various embodiments are conceivable.

Crosses may for example be made per pair (e.g. by randomly choosing two samples (“father”, “mother”) which are crossed to obtain two new samples (“children”). In one embodiment, the crossing method is a multi-point cross. In one embodiment, the crossing method is a one-point cross.

Mutations may be made by selecting a gene at random and replacing it with another gene. For example, in one embodiment, the mutation rate may be fixed at m % (between 0.01 and 2%), and gene change follows a uniform law.

At the output of step 340, k mutated and/or crossed samples are obtained. These samples are associated with mission trajectories.

Steps 320, 330 and 340 are reiterated for each type (or constraint) of mission operator.

At output, when all of the mission constraints are satisfied 360, an optimal trajectory is determined (then communicated to the avionics).

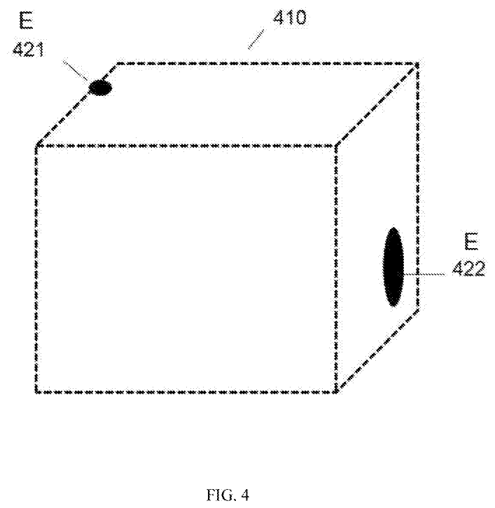

FIG. 4 illustrates, in three dimensions, an exemplary SAR mission 410.

FIG. 4 illustrates, in three dimensions, an exemplary SAR mission 410 with a point of entry (here an entry axis 421) and an exit region (here with an exit axis 422).

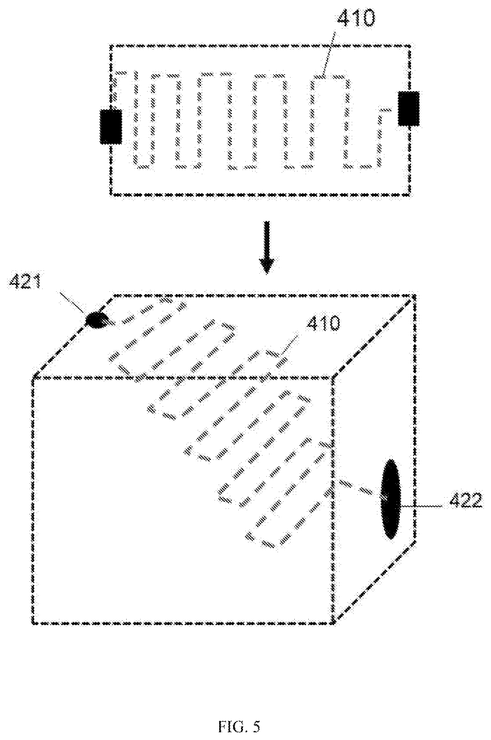

FIG. 5 illustrates the steps of calculating a trajectory for the exemplary SAR mission 410.

For the SAR mission 410, the mission computer determines a type of pattern (e.g. ladder, petal, snail), here a trajectory in a ladder pattern 410. The width between the rungs may be dependent on the required resolution, on the altitude, on the required level of coverage, on the imaging speed, on the vehicle speed, etc. The entry axis 421 will determine the orientation of the short and long “rungs”. Typically, for an EO electro-optical sensor aimed downwards, of constant aperture, the lower the aircraft, the smaller the ground footprint, and therefore the “rungs” will have to be brought closer together in order to obtain equivalent coverage. If however the sensor has a variable aperture, it is possible to act on the aperture in order to maintain an identical footprint (since the resolution gets better the closer to the ground, it may be advantageous to open the field of the sensor as the aircraft descends).

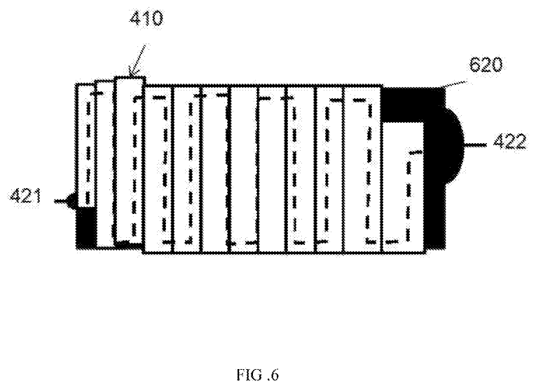

FIG. 6 illustrates the image coverage by the sensor according to the trajectory 410. The figure illustrates the coverage by the sensor 410 (images with intersections) and the regions that are not covered 620. The successive taking of images may in particular be dependent on the speed of the aircraft and the imaging speed of the image sensor.

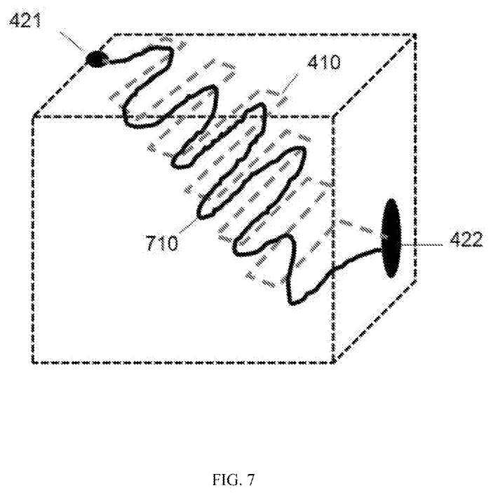

FIG. 7 illustrates the actual trajectory 710 of the aircraft. The actual trajectory 710 of the aeroplane attempts to follow the mission trajectory 410 as closely as possible. The resulting trajectory 710 is that predicted or calculated by a flight management system (FMS) and executed by the autopilot (AP).

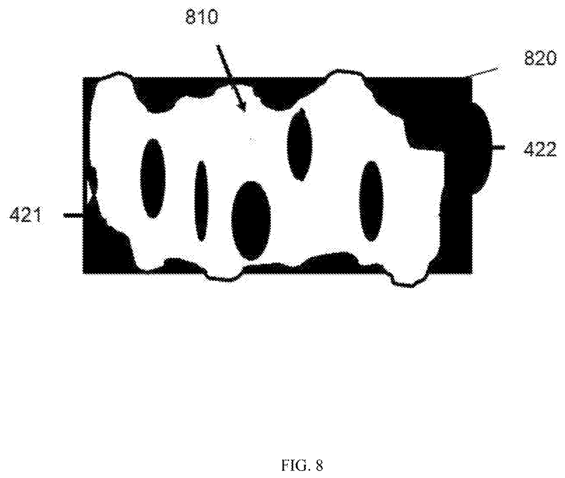

FIG. 8 illustrates the actual coverage 810 of the sensor. The actual coverage of the sensor 810 features regions that are not covered 820 (and not envisaged).

The present invention may be implemented on the basis of hardware and/or software elements. It may be available as a computer program product on a computer-readable medium. The computer may be a rack, a tablet or an EFB (electronic flight bag), or a software portion integrated into the FMS (flight management system), etc. The medium may be electronic, magnetic, optical or electromagnetic.

In terms of hardware, the embodiments of the invention may be carried out by computer. For example, distributed architecture of “cloud computing” type may be used. Peer-to-peer servers, completely or partially distributed (existence of centres) may interact. One or more databases may be used, centralized and/or distributed. Implementation of the invention by blockchain is possible and does not prevent the existence of one or more privileged nodes, in the case of a private cloud or private blockchain. A blockchain allows the sharing of data between entities whose interests are not necessarily congruent, and allows secure recording of flight events (history, traceability, confidence in the data, etc.). Smart contracts made on a blockchain may make it possible to program said blockchain, and allow secure execution of programs. The access may be multiplatform (e.g. from EFB, WebApp, ground access, etc.).

In one embodiment, an aircraft or drone is equipped with a module for communicating and collaboratively sharing data from the computers on board the aircraft. This hardware module may be connected with a range of users (consumers) and/or suppliers (producers) of data. The avionic equipment may interact (bilateral communication) with non-avionic equipment. In some cases, communications may be unilateral (from the avionics to the non-avionics, but not the other way around, i.e. to avoid the injection of erroneous or malicious data from the open world to the certified avionics world). FMS flight management systems may be networked with one another, as well as with EFBs.

1. A machine learning method implemented by computer for assisting in the management of the mission trajectory of an aircraft, comprising the steps of:
receiving learning data, comprising mission trajectories, determined by an MMS mission computer, a mission trajectory being associated with mission constraints, and actual trajectories, referred to as avionic trajectories, determined by an FMS flight management system and/or an AP autopilot system, referred to as FMS/AP avionic systems.
executing a machine learning algorithm by means of neural network on the learning data, said machine learning algorithm using a cost function, in particular a mission score associated with each avionic trajectory, according to predefined criteria;
generating a trained model for assisting in the management of the mission trajectory of an aircraft.

2. The method according to claim 1, wherein the machine learning comprises reinforcement supervised learning.

3. The method according to claim 1, wherein the machine learning comprises a GFT genetic fuzzy-logic decision tree.

4. The method according to claim 1, wherein the machine learning comprises the implementation of a genetic algorithm, which generates mission trajectories and then selects one or more trajectories generated, the generation consisting in breaking a mission trajectory down into a plurality of genes, comprising elementary geometric units associated with attributes, then in randomly mixing one or more broken-down trajectories and/or randomly replacing one or more genes with others.

5. The method according to claim 4, wherein the implementation of a genetic algorithm comprises the steps of:
breaking one mission trajectory from among X down into a succession of N unitary geometric elements, each elementary unit being associated with P attributes, the various combinations N×P being called genes, and one attribute being chosen from among the speed, altitude, direction of the aircraft comprising in particular the roll axis, the pitch axis, and the yaw axis;
performing one or more crosses and/or one or more mutations of genes, in order to generate mission trajectories; a cross being performed by randomly intermixing one or more trajectories, and a mutation being able to be made by selecting a gene at random and replacing the selected gene with another gene;
determining the mission score for each mission trajectory generated;
selecting one or more mission trajectories according to the mission scores; said selection being performed by thresholding and/or by means of threshold ranges and/or by filtering by analytic function and/or by algorithm-computable filtering.

6. The method according to claim 4, further comprising the step of implementing a fuzzy-logic algorithm configured to generate the trajectories, the genetic algorithm allowing the fuzzy-logic control parameters to be selected from among all of the trajectories generated.

7. The method according to claim 1, wherein the machine learning comprises deep learning.

8. The method according to claim 1, a mission constraint comprising one or more of the parameters comprising a mission type, a geographical region, a point of entry into and/or of exit from said geographical region, time management, fuel management and/or a quality of service as a target regarding one or more sensors on board the aircraft.

9. The method according to claim 1, a mission score being a ratio of a target or expected quality of service associated with the mission trajectory to a resulting quality of service associated with the avionic trajectory corresponding to the mission trajectory, a quality of service being associated with at least one or more onboard sensors.

10. The method according to claim 1, wherein the trained model determines an optimized mission trajectory, which satisfies the mission constraints received and compliant for the avionic systems.

11. The method according to claim 1, wherein one or more of the results of intermediate calculations, information relating to the root causes and/or the computing context of one or more of the steps of the method is the subject of display in a human-machine interface.

12. A computer program product, comprising program code instructions for implementing the steps of the method according to claim 1 when said program runs on a computer.

13. A machine learning system for assisting in the management of the mission trajectory of an aircraft, comprising:
an MMS mission computer, configured to determine mission trajectories on the basis of mission constraints;
an FMS flight management system and/or an AP autopilot system, referred to as FMS/AP avionic systems.
one or more processors configured to determine an evaluation, in particular a mission score associated with each avionic trajectory, according to predefined criteria;
a neural network configured to perform machine learning between the mission trajectories communicated by the MMS mission computer on the one hand and said mission scores.

14. The system according to claim 13, wherein one or more processors are configured to implement a genetic algorithm and/or a fuzzy-logic algorithm.

15. The system according to claim 13, a neural network being chosen from among the neural networks comprising: an artificial neural network; an acyclic artificial neural network; a recurrent neural network; a feedforward neural network; a convolutional neural network; and/or a generative adversarial neural network.
